(19) United States
(12) Patent Application Publication
(10) Pub. No.: US 2009/0113484 A1
(43) Pub. Date: Apr. 30, 2009

(54) IMAGE OUTPUT DEVICE, DISPLAY AND IMAGE PROCESSING METHOD

(75) Inventor: Sheng-Nan Sun, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/967,262

(22) Filed: Dec. 31, 2007

(30) Foreign Application Priority Data
Oct. 24, 2007 (TW) 96139838

(51) Int. Cl. G06F 3/00; H04N 5/445

(52) U.S. Cl. 725/56; 725/38

(57) ABSTRACT

An image output device and image processing method are provided. The device includes a front end control unit and a color blending processing unit. The front end control unit switches a first program channel to a second program channel according to a channel switching signal and stores a final frame data of the first program channel and an initial frame data of the second program channel. The color blending processing unit receives a blending information and blends the final frame data of the first program channel and the initial frame data of the second program channel according to the blending information. Thus, the transition frame produced by the color blending processing unit is displayed between the final frame of the first program channel and the initial frame of the second program channel.

### CROSS-REFERENCE TO RELATED APPLICATION

This application claims the priority benefit of Taiwan application serial no. 96139838, filed on Oct. 24, 2007. The entirety of the above-mentioned patent application is hereby incorporated by reference herein and made a part of this specification.

### BACKGROUND OF THE INVENTION

1. Field of the Invention

The present invention relates to an image output device, a display and an image processing method. More particularly, the present invention relates to an image output device having a dynamic transition frame, and a display and an image processing method thereof.

2. Description of Related Art

With a quick development of multimedia techniques, various video services such as terrestrial broadcasting, satellite broadcasting, cable broadcasting, network television (TV) etc. are widely used, such that a user may enjoy a high quality audio-visual service wherever they are. Therefore, as long as the user owns an audio-visual product such as a TV, a set-top box which may receive signals of the aforementioned services, the user may immediately enjoy a plurality of interesting programs.

However, when the user watches a TV program, he may select a preferred one, and therefore channel switching is inevitable. During channel switching, a black frame may be inserted between a frame of a previous program and a frame of a next program by the TV/set-top box, or the frame of the previous program may be directly switched to the frame of the next program.

FIG. 1 is diagram illustrating a program channel switching process of a general TV or a set-top box. Referring to FIG. 1, a referential number 120 represents steps of a switching process of the displayed frames. Referential numbers 130 and 132 represent the steps of program channel switching process of a built-in or an external set-top box. First, in step 122, assuming a frame 110 being watched by the user is the frame of program A of a certain channel. When the TV or the set-top box receives a channel switching request, namely, in step 130, when an interrupt enable request for channel switching is received, the displayed frame may be fixed to a final frame of the program A or fixed to a predetermined inserted black frame, shown as step 124. Next, after the interrupt request for channel switching is enabled, the TV or the set-top box may control an inner network interface module (NIM) to connect with another channel according to the interrupt request, shown as an operation of front end adjustment of step 132. After the NIM is controlled to output the frame of a program B, the displayed frame is switched to the frame of the program B of another channel, shown as step 126. Therefore, the frames displayed during channel switching are shown on the top of FIG. 1 in a sequence of a frame A 110→a final frame or a black frame 112→a frame B 114.

According to the above conventional channel switching process, the frame displayed by the TV or the set-top box are relatively tedious, namely, during a waiting time for channels switching, the user may only watch a tedious fixed frame or a black frame, and accordingly pleasure of watching TV programs may be reduced. Therefore, if a transition effect may be displayed during channel switching, the pleasure of watching TV programs may be improved, and an entertainment may be increased.

### SUMMARY OF THE INVENTION

The present invention is directed to an image output device, by which a user may watch transition frames during program channel switching, such that a pleasure of watching TV program is improved.

The present invention is directed to an image processing method, which is applied to an image output device, by which transition frames may be displayed during program channel switching, such that a user may not have to watch a tedious fixed frame or a black frame, and meanwhile may learn about an operation status via the transition frames.

The present invention provides an image output device including a front end control unit and a color blending processing unit. The front end control unit switches a first program channel to a second program channel according to a channel switching signal and stores a final frame data of the first program channel and an initial frame data of the second program channel. The color blending processing unit receives blending information and blends the final frame data of the first program channel and the initial frame data of the second program channel according to the blending information to generate a plurality of transition frames. The transition frames are then displayed between the final frame of the first program channel and the initial frame of the second program channel.

The present invention provides another image output device including a front end control unit, a color blending processing unit and a screen. The front end control unit switches a first program channel to a second program channel according to a channel switching signal and stores a final frame data of the first program channel and an initial frame data of the second program channel. The color blending processing unit receives blending information and blends the final frame data of the first program channel and the initial frame data of the second program channel according to the blending information to generate a plurality of transition frames. The transition frames are then displayed between the final frame of the first program channel and the initial frame of the second program channel. The screen is used for displaying the transition frames.

The present invention provides an image processing method including switching a first program channel to a second program channel according to a channel switching signal, and storing a final frame data of the first program channel and an initial frame data of the second program channel; blending the final frame data of the first program channel and the initial frame data of the second program channel according to the blending information to generate a plurality of transition frames corresponding to the channel switching signal, such that the transition frames may be displayed between the final frame of the first program channel and the initial frame of the second program channel.

According to the present invention, during program channel switching, the transition frames are displayed between the frame of the previous program channel and the frame of the next program channel, so as to substitute the conventional fixed frame or the black frame, and therefore the user may watch vivid dynamic images instead of tedious dull images during channel switching, and accordingly the pleasure of watching TV programs may be improved, and an entertainment may be increased.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is diagram illustrating a program channel switching process of a general TV or a video box.

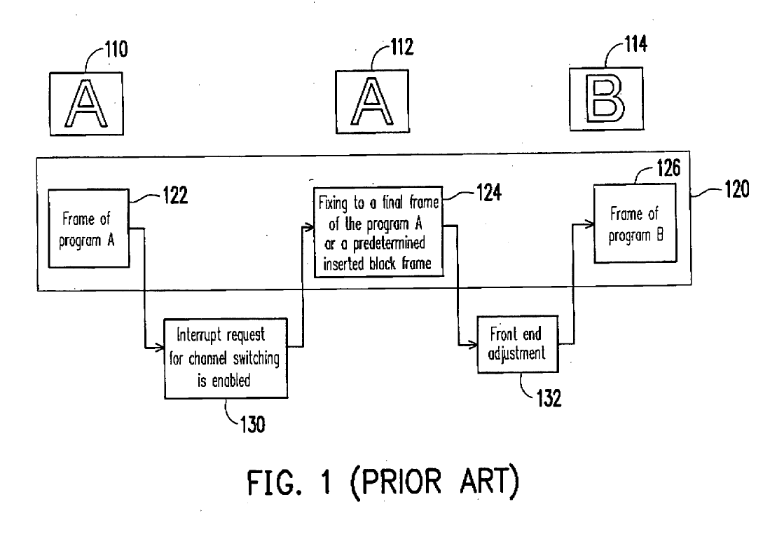

FIG. 2A is a block diagram illustrating an image output device according to an embodiment of the present invention.

FIG. 2B is a schematic diagram illustrating a program channel switching process of an image output device according to an embodiment of the present invention.

FIG. 3 is a circuit block diagram further illustrating an image processing process according to FIG. 2B.

FIG. 4 is a schematic diagram illustrating a transition processing of a color blending processing unit according to an embodiment of the present invention.

### DESCRIPTION OF EMBODIMENTS

The present invention provides an image output device, by which a user may watch transition frames during program channel switching, such that a pleasure of watching TV program of the user may be improved. The present invention also provides an image processing method, which may be applied to an image output device, by which transition frames may be displayed during program channel switching, such that a user may not have to watch a tedious fixed frame or a black frame, and meanwhile may learn about an operation status via the transition frames.

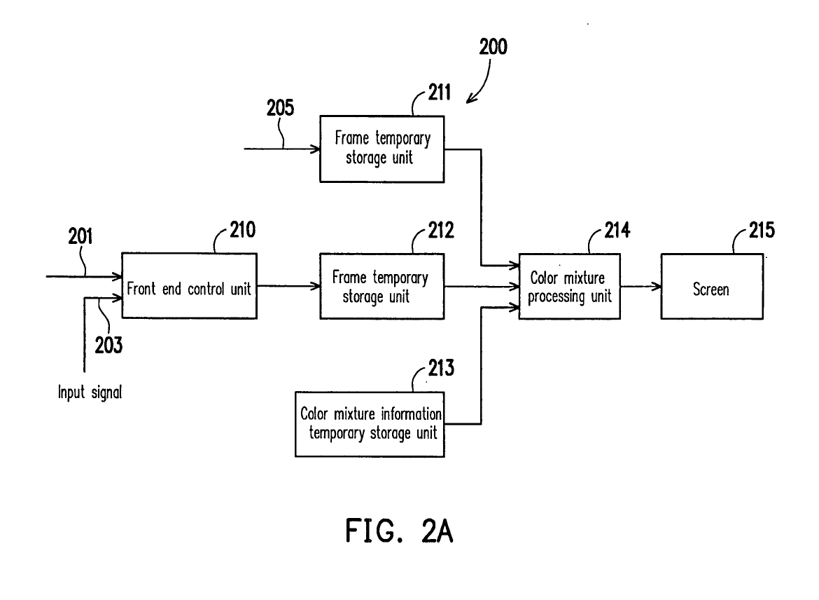

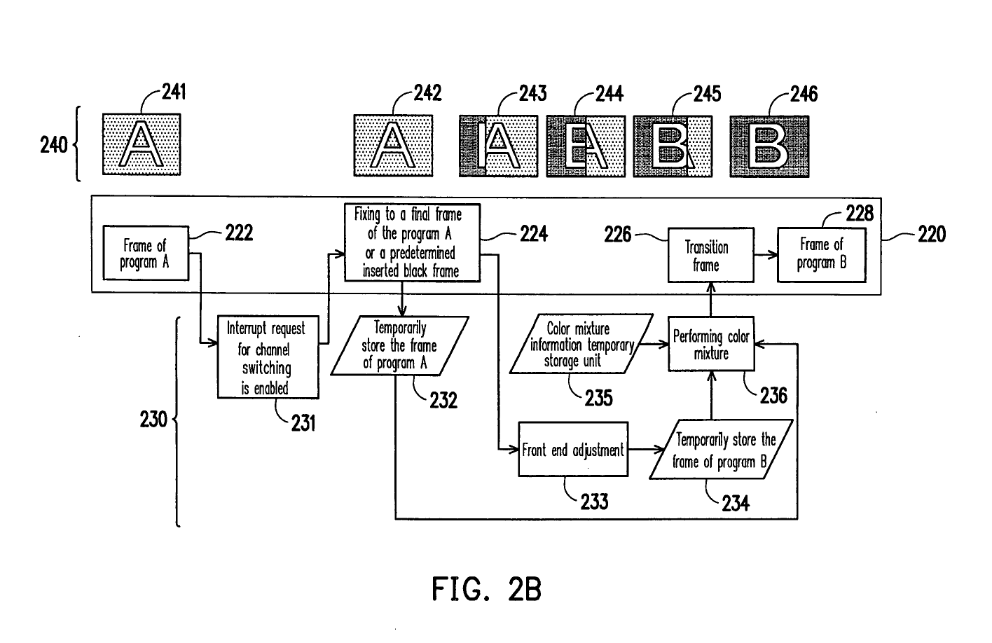

FIG. 2A is a block diagram illustrating an image output device according to an embodiment of the present invention. Referring to FIG. 2A, an image output device 200 includes a front end control unit 210, frame temporary storage units 211 and 212, a color blending information temporary storage unit 213 and a color blending processing unit 214. The front end control unit 210 receives a control signal 201 and an input signal 203. The control signal 201 is used for controlling whether or not to enable the channel switching interrupt request. When the control signal 201 is received to perform the channel switching, a TV or a set-top box will control an inner NIM (Network Interface Module) to switch to another channel from the present channel according to the interrupt request. The input signal 203 is a TV signal used for transmitting a program. The NIM may be a front end control interface used for terrestrial broadcasting, satellite TV, cable TV or internet protocol (IP) TV etc. Taking a digital TV of the terrestrial broadcasting for an example, the digital TV of the terrestrial broadcasting may control a setting of a demodulator and a tuner via an IIC interface, so as to obtain a desired transport stream of audio-visual signals.

The front end control unit 210 is coupled to the frame temporary storage unit 212, and transmits the program frames displayed by the switched channel to the frame temporary storage unit 212, and stores an initial frame of the switched channel. The other frame temporary storage unit 211 receives a channel switching interrupt enable request, and meanwhile stores a final frame of a present program.

The color blending processing unit 214 is used for reading the stored frame data from the frame temporary storage units 211 and 212, and blending the frame data to perform a transition processing, so as to generate sequential frames with a transition effect. During transition processing, blending information corresponding to the transition processing mode is read from the color blending information temporary storage unit 213 to control an adjustment of a color blending ratio and an alpha value etc. of the output frame. The transition processing mode includes a lot of variations, and diversified transition effects such as edge wipe, central wipe, slide wipe, radio wipe or a fade-out effect of dynamic images may all be applied to the transition processing of the present invention. For example, an alpha blending information, which may divide the input data into three parts, the alpha blending technique is to perform color blending to textures according to the alpha to achieve a transparent effect, and image blending is generally performed according to the alpha value.

FIG. 2B is a schematic diagram illustrating a program channel switching process of an image output device according to an embodiment of the present invention. Referring to FIG. 2B, a referential number 220 represents steps of a switching process of the displayed frames. A referential numbers 230 represents the steps of program channel switching process of a built-in or an external set-top box. The referential number 240 represents the displayed frames.

First, in step 222, assuming a frame 241 watched by the user is the frame of program A of a channel. When the TV or the set-top box receives a channel switching request, namely, in step 231, when an interrupt enable request for channel switching is received, the displayed frame is fixed to a final frame of the program A and the image data thereof is temporarily stored, shown as step 232. Next, after the interrupt request for channel switching is enabled, the TV or the set-top box will control an inner NIM to connect with another channel according to the interrupt enable request, shown as an operation of front end adjustment of step 233. After the NIM is controlled to output a frame of a program B, the frame of the program B is temporarily stored, as shown in step 234.

Next, in step 236, color blending is performed, by which the temporarily stored frames of the program A and the program B are read, and the blending information corresponding to the transition processing mode is read from a color blending information temporary storage unit 235 to control an adjustment of the color blending ratio and the alpha value etc. of the output frame, and then sequential transition frames 226 with the transition effect are generated and transmitted to the TV. Next, in step 228, the frame of program B is displayed.

The frames displayed on the screen and represented by the referential number 240 include a frame 241 of the original program A, the transition frames 242, 243, 244 and 245 sequentially displayed on the screen after the channel switching interrupt request being enabled, and the frame of program B.

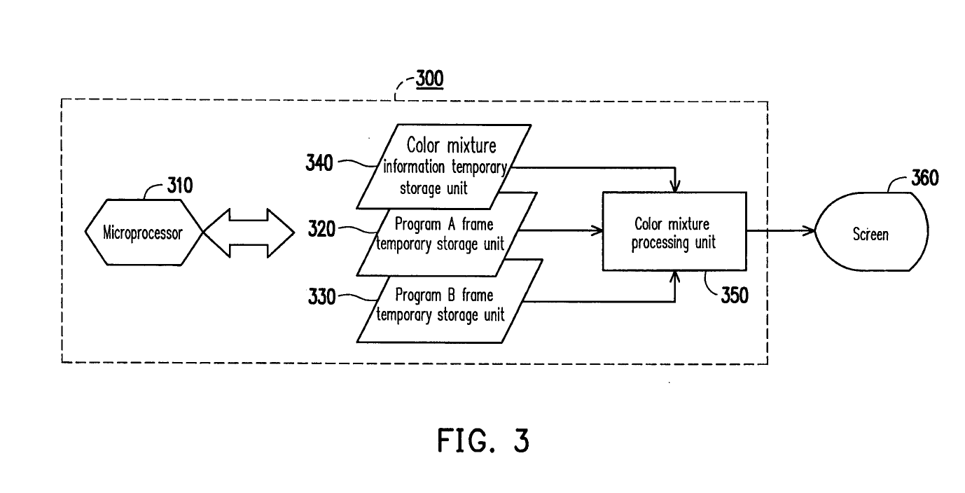

FIG. 3 is a circuit block diagram further illustrating an image processing process according to FIG. 2B. A microprocessor 310 controls a data stream transmitting and receiving among a program A frame temporary storage unit 320, a program B frame temporary storage unit 330, a color blending information temporary storage unit 340 and a color blending processing unit 350. The microprocessor 310 further controls and renews the blending information stored in the color blending information temporary storage unit 340, so as to control an adjustment of the color blending ratio and the alpha value etc. of the output frame. Under control of the microprocessor 310, the color blending processing unit 350 reads the blending information corresponding to the transition processing mode from the color blending information temporary storage unit 340 to control the adjustment of the color blending ratio and the alpha value etc. of the output frame, and generates the sequential transition frames with the transition effect, and transmits the transition frames to the screen 360 for displaying. After that, the frame of the program B is displayed.

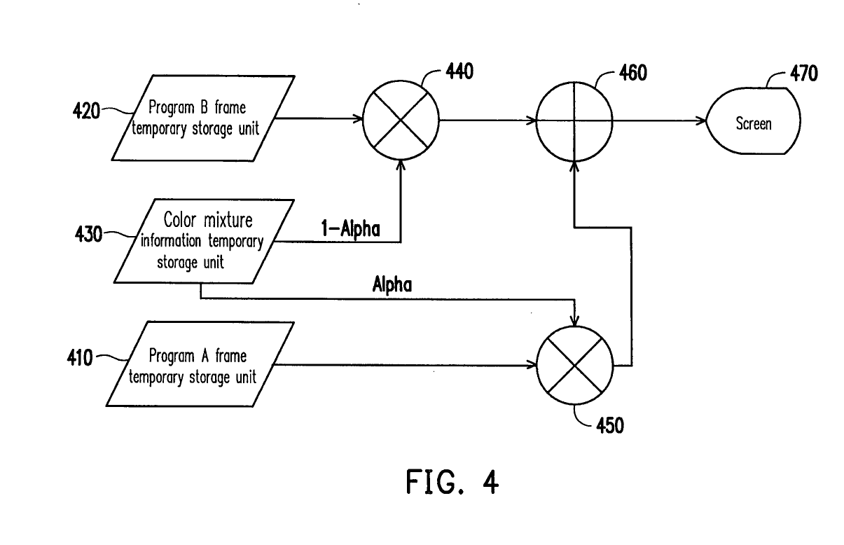

Furthermore, FIG. 4 is a schematic diagram illustrating a transition processing of a color blending processing unit according to an embodiment of the present invention. Referring to FIG. 4, the transition frames is generated by calculating the final frame data of a first program channel and an initial frame data of a second program channel according to the alpha value of the blending information, which is shown as the following equation (1):

Dout(x,y)=D1(x,y)*A(x,y)+D2(x,y)*(1−A(x,y)) (1)

where, x represents a horizontal position of the frame; y represents a vertical position of the frame; A(x,y) represents the alpha value at coordinates (x,y), wherein the A(x,y) has different alpha values at different locations, so as to achieve the transition effect; D1(x,y) represents the frame data of the final frame of the first program channel located at the coordinates (x,y), D2(x,y) represents the frame data of the initial frame of the second program channel located at the coordinates (x,y), and Dout(x,y) represents the frame data of the transition frame located at the coordinates (x,y).

As shown in FIG. 4, the data D1(x,y) stored in a program A frame temporary storage unit 410 is multiplied with the alpha value A(x,y) (i.e. “Alpha” shown in FIG. 4) stored in a color blending information temporary storage unit 430 via a multiplier 450. The data D2(x,y) stored in a program B frame temporary storage unit 420 is multiplied with the alpha value 1−A(x,y) (i.e. “1-Alpha” shown in FIG. 4) stored in a color blending information temporary storage unit 430 via a multiplier 440. The two multiplier 440 and 450 output calculation results to an adder 460, such that the sequential frames with the transition effect may be obtained after the channel switching interrupt request is enabled, and may be sequentially displayed on the screen 470. After that, the frame of the program B is displayed.

Moreover, as to the color blending ratio, frame color may be changed by adjusting pixel colors or block colors within the frame. For example, as to a color space of the three primary colors and the alpha value (RGBA), the red (R), green (G), blue (B) and the alpha value (A) are 8 bits each, and total 32 bits; or as to a color space of a video system and the alpha value (YUVA), the luminance (Y) is 8 bits, the chroma (UV) are 7 bits each, and the alpha value (A) is 2 bits, and total 16 bits.

In summary, according to the present invention, during channel switching, the transition frames are displayed between the final frame of the first program channel and the initial frame of the second program channel, so as to substitute the conventional fixed frame or the inserted black frame, and accordingly the tedious dull images may be avoided, and vivid dynamic images during channel switching may be achieved. Therefore, pleasure of watching TV programs may be improved, and an entertainment may be increased, and meanwhile the user may learn about an operation status via the transition frames.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image output device, for receiving frame data of a plurality of program channels, the image output device comprising:
a front end control unit, for switching a first program channel to a second program channel according to a channel switching signal and storing a final frame data of the first program channel and an initial frame data of the second program channel; and
a color blending processing unit, for receiving a blending information and blending the final frame data of the first program channel and the initial frame data of the second program channel according to the blending information to generate a plurality of transition frames corresponding to the channel switching signal, so as to display the transition frames between the final frame of the first program channel and the initial frame of the second program channel.

2. The image output device as claimed in claim 1 further comprising:
a color blending information temporary storage unit, for storing the plurality of blending information, and selectively outputting the blending information under control of the front end control unit, such that the color blending processing unit may perform the blending based thereon.

3. The image output device as claimed in claim 1, wherein the blending information comprises a color blending ratio and an alpha value of a frame.

4. The image output device as claimed in claim 1, wherein the transition frames are dynamic images with an edge wipe, a central wipe, a slide wipe, or a fade-out effect.

5. A display device, comprising:
a front end control unit, for switching a first program channel to a second program channel according to a channel switching signal and storing a final frame data of the first program channel and an initial frame data of the second program channel;
a color blending processing unit, for receiving a blending information and blending the final frame data of the first program channel and the initial frame data of the second program channel according to the blending information to generate a plurality of transition frames corresponding to the channel switching signal, so as to display the transition frames between the final frame of the first program channel and the initial frame of the second program channel; and
a screen, for displaying the transition frames.

6. The display device as claimed in claim 5 further comprising:
a color blending information temporary storage unit, for storing the plurality of blending information, and selectively outputting the blending information according to a selection signal, such that the color blending processing unit may perform the blending based thereon.

7. The display device as claimed in claim 5, wherein the blending information comprises a color blending ratio and an alpha value of a frame.

8. The display device as claimed in claim 5, wherein the transition frames are dynamic images with an edge wipe, a central wipe, a slide wipe, or a fade-out effect.

9. An image processing method, for generating a transition frame, the image processing method comprising:
switching a first program channel to a second program channel according to a channel switching signal and storing a final frame data of the first program channel and an initial frame data of the second program channel; and
blending the final frame data of the first program channel and the initial frame data of the second program channel according to a blending information to generate a plurality of transition frames corresponding to the channel switching signal, so as to display the transition frames between the final frame of the first program channel and the initial frame of the second program channel.

10. The image processing method as claimed in claim 9 further comprising:
selectively outputting one of the blending information according to a selection signal for the blending being performed based thereon.

11. The image processing method as claimed in claim 9, wherein the select blending information comprises a color blending ratio and an alpha value of a frame.

12. The image processing method as claimed in claim 9, wherein the transition frames are dynamic images with an edge wipe, a central wipe, a slide wipe, or a fade-out effect.
